(19) United States
(12) Patent Application Publication
(10) Pub. No.: US 2017/0142444 A1
(43) Pub. Date: May 18, 2017

(54) METHOD OF ENCODING A DIGITAL IMAGE, DECODING METHOD, DEVICES, AND ASSOCIATED COMPUTER PROGRAMS

(71) Applicants: B<>COM, Cesson Sevigne (FR); Orange, Paris (FR)

(72) Inventor: Felix Henry, Saint Gregoire (FR)

(21) Appl. No.: 15/322,156

(22) PCT Filed: Jun. 16, 2015
(86) PCT No.: PCT/FR2015/051587

§ 371 Date: Dec. 26, 2016

(30) Foreign Application Priority Data
Jun. 27, 2014 (FR) 1456032

(51) Int. Cl. H04N 19/61; H04N 19/115; H04N 19/132; H04N 19/91; H04N 19/154; H04N 19/18; H04N 19/463; H04N 19/103; H04N 19/134

(52) U.S. Cl. CPC H04N 19/61; H04N 19/103; H04N 19/115; H04N 19/132; H04N 19/134; H04N 19/154; H04N 19/18; H04N 19/463; H04N 19/91

(57) ABSTRACT

A method of encoding a digital image that is divided into a plurality of blocks of pixels. The method includes, for a current block: predicting the current block values from at least one block previously processed; calculating a residual block; obtaining a residual block by applying a transform to pixels of the residual block; selecting coefficients signs to be predicted in the transformed residual block; predicting the selected signs encoded and decoded neighbouring blocks; calculating a prediction indicator from the predictions of the selected signs and their original values; entropic encoding the indicators obtained for the predicted signs; and determining a context of a coefficient of the current residual block and the sign of a coefficient of the transformed residual block is selected based on a predetermined score associated with the encoding context of the coefficient, the score being representative of a reliability level of the prediction of the sign.

### 1. CROSS-REFERENCE TO RELATED APPLICATIONS

This application is a Section 371 National Stage Application of International Application No. PCT/FR2015/051587, filed Jun. 16, 2015, the content of which is incorporated herein by reference in its entirety, and published as WO 2015/197945 on Dec. 30, 2015, not in English.

### 2. FIELD OF THE INVENTION

The field of the invention is that of signal compression, in particular of a digital image or of a sequence of digital images, in which a prediction of a portion of the signal to be coded is made from a portion of the already encoded signal.

The coding/decoding of digital images applies in particular to images coming from at least one video sequence comprising:
images coming from the same camera and succeeding each other temporally (2D-type coding/decoding),
images from different cameras oriented according to different views (3D-type encoding/decoding),
corresponding texture and depth components (3D-type encoding/decoding),
etc.

The present invention applies in a similar manner to the 2D- or 3D-type coding/decoding of images.

The invention may especially, but not exclusively, apply to the video encoding implemented in the current AVC and HEVC video encoders and their extensions (MVC, 3D-AVC, MV-HEVC, 3D-HEVC, etc.) and to the corresponding decoding.

The invention can also be applied to audio coding, for example implemented in current audio encoders (EVS, OPUS, MPEG-H, etc.) and their extensions and to the corresponding decoding.

### 3. PRESENTATION OF THE RELATED ART

A conventional compression scheme of a digital image is considered, in which the image is divided into blocks of pixels. A current block to be encoded is predicted from a previously encoded decoded block. A residual block is obtained by subtracting the original values from the predicted values. It is then transformed using a DCT (Discrete Cosine Transform) or wavelet transform. The transformed coefficients are quantized and then their amplitudes are subjected to an entropy coding of the Huffmann or arithmetic type. Such encoding obtains efficient performances because, due to the transformation, the values of the amplitudes to be encoded are largely zero.

However, it does not apply to the values of the coefficients signs, the values + and − are usually associated with equivalent probabilities of occurrence. Thus, the signs of the coefficients are encoded by a bit 0 or 1.

We know from the article by Koyama, J. et al, entitled “Coefficient sign bit compression in video coding,” and published in the proceedings of the conference “Picture Coding Symposium (PCS)”, in May 2012, a selection method of signs of coefficients of a residue block to be predicted. The proposed selection is based on a predetermined number of coefficients as a function of their amplitude and the size of the block from which they are derived. Selected signs are predicted. The predictions obtained are compared with the original values of the signs to determine the value of a prediction indicator, also called the residue of a predicted sign. This indicator can take on two values, which are a first value representative of a correct prediction and a second value representative of an incorrect prediction. The rest of the signs are encoded explicitly, without prediction.

An advantage of such selection is to predict the value of a sign with a correct prediction probability greater than 50%, thus to allow the application of entropy coding to the values of prediction indicators. This entropic encoding encodes the sign information with an average bit rate of less than one bit per sign, thereby increasing the compression ratio.

### 4. DISADVANTAGES OF THE PRIOR ART

Nevertheless, this technique has at least two major disadvantages:
Certain signs, whose probability of correct prediction is close to 50%, enter the selection of coefficients to be predicted. If this has no impact on compression performance (no gain), there is an unnecessary increase in the number of calculations to be performed;
Certain coefficients whose probability of correct prediction is high (greater than 50%) are not retained in the selection of coefficients to be predicted. There is then a loss of compression efficiency, because these coefficients could be used to further reduce the size of the encoded signal.

### 5. SUMMARY OF THE INVENTION

These objectives, as well as others which will appear hereinafter, are achieved by means of an encoding method of a digital image, said image being divided into a plurality of blocks of pixels processed in a set order, said method comprising the following steps, implemented for a current block:
predicting the current block values from at least one block previously processed in a mode of prediction selected from a plurality of predetermined modes,
calculating a residual block by subtracting the predicted values from the original values of the current block,
Obtaining a transformed residual block by applying a transform to pixels of the residual block, said transformed residual block comprising coefficients,
Selecting the coefficients signs to be predicted in the transformed residual block;
Predicting the signs selected;
Calculating a prediction indicator of the signs selected from the predictions of the selected signs and their original values, the indicator being intended for taking a value among a group comprising:
   a first value representative of a correct prediction;
   a second value representative of an incorrect prediction;
Entropic encoding of the values of indicators obtained for the predicted signs.

According to the invention, the method comprises a step of determining a context of a coefficient of the current residual block among a plurality of predetermined contexts, using at least one characteristic belonging to a group comprising at least a size of the block, the amplitude of the coefficient, the coefficient frequency and the prediction mode of the current block, and the sign of a coefficient of a current block to be predicted is selected according to a predetermined score associated with the encoding context of the coefficient, said score being representative of a reliability level of the prediction of the sign.

Thus, the invention relies on an entirely novel and inventive approach to image encoding, which consists in predicting the value of the signs of the coefficients of a residual block, when their prediction is considered as sufficiently reliable. To do this, a coefficient is associated with an encoding context for which values of scores representative of a reliability level have previously been established.

Unlike the prior art which selects a predetermined number of signs to be predicted as a function of the amplitude of their coefficient and the size of the block from which they are derived, the invention bases its selection on a pre-established reliability of the prediction of signs in a particular encoding context.

An encoding context of a coefficient can be defined by a set of encoding characteristics of the coefficient and of the block to which it belongs. It is understood that the reliability of the prediction of the sign varies according to such characteristics.

With the invention, a plurality of contexts are thus defined, associated with levels of reliability distinct from one another.

The characteristics taken into account to define the encoding context of the coefficient correspond to those for which an impact on the reliability of the prediction result has been observed. For example, sign predictions were found to be more reliable for a large block (for example, 16×16 or 32×32 pixels) than for a small block (eg 4×4 or 8×8 pixels). Similarly, the prediction of a sign is more reliable for a low frequency coefficient than a high frequency coefficient.

The invention thus makes it possible to solve the technical problem of the cost of encoding signs of the coefficients of a residual block in an encoding scheme of a digital image. Indeed, with the invention, it is first ensured that the values of the prediction indicators of the predicted signs that are actually encoded in the bit stream, will take on the value representing a correct prediction in the great majority of cases, in order to provide a context favourable to entropic encoding and thus to guarantee an improved compression performance.

According to an advantageous characteristic of the invention, the score is predetermined during a preliminary step of estimating a probability of correct prediction of the sign in the context of the coefficient.

Thus, the score corresponds to the exact value of correct probability of prediction, which ensures a maximum level of performance of the compression.

For example, these probabilities are constructed for an encoding context of the predetermined coefficient, before encoding and decoding, either by statistical accumulation on a set of signals representative of the signals to be encoded, or by mathematical calculation based on hypotheses on the distribution of the signs of the coefficients.

According to another aspect of the invention, the sign of a quantized coefficient is selected when said score is greater than a predetermined threshold.

The higher the score, the more reliable the prediction of the sign of the coefficient is. The selection is made by comparing the score of the coefficient with a threshold and the sign of the coefficient is selected, when the score of the coefficient is greater than this threshold.

An advantage of such a solution is that it is simple and economical in computational resources.

According to another aspect of the invention, the score can take on binary values, a first value being representative of a sign to be predicted, a second value being representative of a sign not to be predicted.

In this embodiment, the score is binary. The signs selected are those associated with a score representative of a level of reliability considered sufficient. This makes it possible to reduce the complexity of the method since there is no longer any comparison of the score with a pre-established threshold, insofar as the score itself is indicative of the selection or non-selection of a given sign.

According to yet another aspect of the invention, the value of the threshold is predetermined.

The threshold value is set. It is known to the encoder and the decoder. For example, it is determined empirically by statistical analysis of the performances of the entropic encoding applied to the predicted signs on a representative set of samples.

An advantage of this solution is that it is simple and easy to implement.

According to yet another aspect of the invention, the value of the threshold is adapted during encoding as a function of encoding characteristics.

The value of the threshold may vary during encoding depending on the characteristics of the signal or of the unit which carries out the encoding.

An advantage of this solution is that it optimises the performance of entropic encoding over time.

According to a first variant, the threshold value is calculated by the encoder and transmitted to the decoder in the bit stream.

According to a second variant, the value of the threshold is calculated similarly by the encoder and the decoder.

According to yet another aspect of the invention, the step of entropic encoding the prediction indicator value of the sign of a coefficient takes into account the predetermined score associated with the encoding context of the coefficient.

In this way, the best advantage is taken of the a priori knowledge of the reliability level of the prediction of the signs of the current block and the compression performance is improved.

The method which has just been described in its various embodiments is advantageously implemented by a device for encoding a digital image according to the invention. Such a device comprises the following units:
Predicting the current block values from at least one block previously processed in a mode of prediction selected from a plurality of predetermined modes,
Calculating a residual block by subtracting the predicted values from the original values of the current block,
Obtaining a transformed residual block by applying a transform to pixels of the residual block, said transformed residual block comprising coefficients,
Selecting the coefficients signs to be predicted in the transformed residual block;
Predicting the signs selected;
Calculating a prediction indicator of the signs selected from the predictions of the selected signs and their original values, the indicator being intended for taking a value among a group comprising:
   a first value representative of a correct prediction;
   a second value representative of an incorrect prediction;
Entropic encoding of the values of indicators obtained for the predicted signs.

Said device is particular in that it comprises a unit for determining a context of a coefficient of the current residual block among a plurality of predetermined contexts, using at least one characteristic belonging to a group comprising at least the size of the block, the amplitude of the coefficient, the coefficient frequency and the prediction mode of the current block, and in that the sign of a coefficient of the current residual block to be predicted is selected according to a predetermined score associated with the encoding context of the coefficient, said score being representative of a reliability level of the prediction of the sign.

Correlatively, the invention also relates to a method for decoding a digital image. Such a method includes the following steps:
Predicting the current block from at least one block previously processed and information related to a prediction mode of the current block;
Entropic encoding of the encoded amplitudes of the coefficients of a transformed residual block, extracted from the bit stream;
Selecting the signs of the coefficients to be predicted in the transformed residual block;
Predicting the values of the signs selected;
Decoding values of prediction indicators of the signs selected from encoded data extracted from the bit stream, the indicator being intended for taking on a value in a group comprising:
   a first value representative of a correct prediction;
   a second value representative of an incorrect prediction;
Calculating decoded values of the signs selected from the decoded prediction indicator values;
Reconstructing coefficients of the residual block from the decoded amplitudes, and decoded signs.

According to the invention, said method is particular in that it comprises a step of determining a context of a coefficient of the current residual block among a plurality of predetermined contexts, using at least one characteristic belonging to a group comprising at least the size of the block, the amplitude of the coefficient, the coefficient frequency and the prediction mode of the current block, and in that the sign of a coefficient of the current residual block to be predicted is selected according to a predetermined score associated with the encoding context of the coefficient, said score being representative of a reliability level of the prediction of the sign.

It will be noted that the step of selecting the signs to be predicted is implemented similarly in the encoding method and in the decoding method. As a result, the various modes or embodiments of the aforesaid encoding method can be added independently or in combination with each other at the steps of the decoding method as defined above.

In particular, according to an aspect of the invention, the score is predetermined during a preliminary step of estimating a probability of correct prediction of the sign in the context of the coefficient.

According to another aspect of the invention, the sign of a quantized coefficient is selected when said score is greater than a predetermined threshold.

According to yet another aspect of the invention, the score can take on binary values, a first value being representative of a sign to be predicted, a second value being representative of an incorrect prediction of the sign of the quantized coefficient.

According to yet another aspect of the invention, the value of the threshold is predetermined.

According to yet another aspect of the invention, the value of the threshold is adapted during decoding as a function of encoding characteristics.

According to yet another aspect of the invention, the step of entropic encoding the prediction indicator value of the sign of a coefficient takes into account the predetermined score associated with the encoding context of the coefficient.

The decoding method which has just been described is advantageously implemented by a device for decoding a digital image according to the invention.

Such a device is particular in that it comprises the following units:
Predicting the current block from at least one block previously processed and information related to a prediction mode of the current block;
Entropic decoding of the encoded amplitudes of the coefficients of a transformed residual block, extracted from the bit stream;
Selecting the signs of the coefficients to be predicted in the transformed residual block;
Predicting the values of the signs selected;
Decoding the values of prediction indicators of the signs selected from encoded data extracted from the bit stream, the indicator being intended for taking on a value in a group comprising:
   a first value representative of a correct prediction;
   a second value representative of an incorrect prediction; and
Calculating the decoded values of the signs selected from the decoded prediction indicator values.

According to the invention, said decoding device is particular in that it comprises a unit for determining a context of a coefficient of the current residual block among a plurality of predetermined contexts, using at least one characteristic belonging to a group comprising at least the size of the block, the amplitude of the coefficient, the coefficient frequency and the prediction mode of the current block, and in that the sign of a coefficient of the current residual block to be predicted is selected according to a predetermined score associated with an encoding context of the coefficient, said score being representative of a reliability level of the prediction of the sign.

Correspondingly, the invention relates to a user terminal.

Such a terminal is particular in that it comprises a device for encoding a digital image and a device for decoding a digital image according to the invention.

The invention also relates to a computer program comprising instructions for implementing the steps of a method for encoding a digital image as described above, when this program is executed by a processor.

The invention also relates to a computer program comprising instructions for implementing the steps of a method for encoding a digital image as described above, when this program is executed by a processor.

These programs can use any programming language. They can be downloaded from a communication network and/or recorded on a computer-readable medium.

Finally, the invention relates to recording media, readable by a processor, integrated or not integrated with the coding device of a digital image and with the device for decoding a digital image according to the invention, optionally removable, storing respectively a computer program implementing a coding method and a computer program implementing a decoding method, as described above.

### 6. LIST OF FIGURES

Other features and advantages of the invention will become evident on reading the following description of one particular embodiment of the invention, given by way of illustrative and non-limiting example only, and with the appended drawings among which:

FIG. 1 shows schematically the steps of the encoding method of a digital image according to an exemplary embodiment of the invention;

FIG. 2 shows schematically a current decoded block of a decoded digital image;

FIG. 3 shows schematically the steps of the encoding method of a digital image according to an exemplary embodiment of the invention;

FIG. 4 shows an example of a simplified structure of a device for encoding a digital image and a decoding device of a digital image according to one embodiment of the invention.

### 7. DESCRIPTION OF A PARTICULAR EMBODIMENT OF THE INVENTION

The general principle of the invention relies on the selection of the signs of coefficients to be predicted as a function of a predetermined score representative of a reliability level of the prediction of the sign for an encoding context associated with the coefficient.

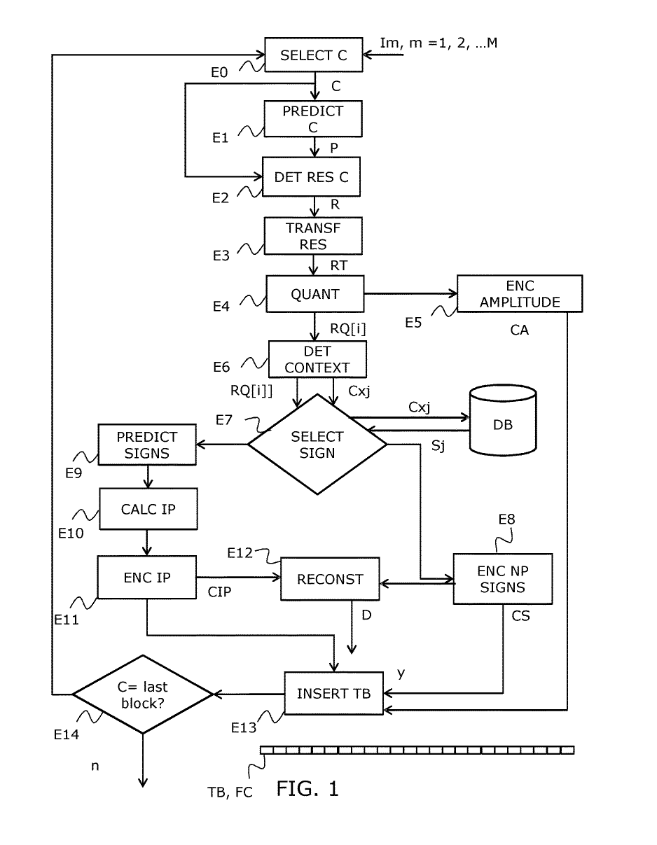

In relation to FIG. 1, an original video is considered, consisting of a sequence of M images I1, I2, . . . IM with M a non-zero integer. The images are encoded by an encoder, the encoded data is inserted in a bit stream TB transmitted to a decoder via a communication network, or a compressed file FC, intended to be stored on a hard disk for example. The decoder extracts the data which are encoded, then received and decoded by a decoder in a predefined order known from the encoder and the decoder, for example in the time order I1, then I2, . . . , then IM, whereas this order may differ according to the embodiment.

When encoding an image Im, where m is an integer between 1 and M, it is subdivided into blocks of maximum size which in turn can be subdivided into smaller blocks. Each block will undergo an encoding or decoding operation consisting of a sequence of operations, including in a non-exhaustive manner a prediction, a residue calculation, a transformation, a quantization and an entropic encoding. This sequence of operations will be described in detail below.

During a step E0, the first block to be processed is selected as the current block C. For example, this is the first block (in lexicographic order). This block comprises N×N pixels.

It is assumed that there exist L cuts in possible blocks numbered from 1 to L, and that the cut used on block C is the cut number 1. For example, there can be 4 possible cuts, in blocks of size 4×4, 8×8, 16×16 and 32×32.

Furthermore, the decoded current image is denoted ID. It will be noted that, in a video encoder, the ID image is (re)constructed in the encoder so that it can be used to predict the other pixels of the video.

During a step E1, a prediction P of the original block C is determined. It is a prediction block constructed by known means, typically by motion compensation (a block originating from a previously decoded reference image) or by intra prediction (a block constructed from the decoded pixels immediately adjacent to the current block in the ID image). The prediction information related to P is encoded in the bit stream TB or compressed file FC. It is assumed here that there are K possible prediction modes m1, m2, . . . , mK, with K a non-zero integer, and that the prediction mode chosen for block C is the mode mk.

During a step E2, an original residue R is formed by subtraction of R=C−P from the prediction P of the current block C in the current block C.

During a step E3, the residue R is transformed into a transformed residue block, called RT, by a transform of the DCT type or wavelet transform, both known to those skilled in the art and in particular implemented in the JPEG standards for DCT and JPEG2000 for wavelet transform.

At E4, the transformed residue RT is quantized by conventional quantization means, for example scalar or vector, into a quantized residue block RQ. This quantized block RQ contains N×N coefficients. In a manner known in the state of the art, these coefficients are scanned in a predetermined order so as to constitute a monodimensional vector RQ [i], where the index i varies from 0 to N²−1. The index i is called the frequency of the coefficient RQ [i]. Conventionally, these coefficients are scanned in ascending order of frequency, for example according to a zigzag path, which is known from the JPEG fixed image encoding standard.

During a step E5, the amplitude information of the coefficients of the residual block RQ is encoded by entropy coding, for example according to a Huffman encoding technique or an arithmetic encoding technique. By amplitude herein is meant the absolute value of the coefficient. Encoding means of the amplitudes are described for example in the HEVC standard and in the article by Sole et al, entitled “Transform Coding Coefficient in HEVC” published in the IEEE Transactions on Circuits and Systems for Video Technology, Volume 22, Issue: 12, pp. 1765-1777, December 2012. Conventionally, it is possible to encode for each coefficient information representative of the fact that the coefficient is non-zero. Then, for each non-zero coefficient, one or more pieces of information relating to the amplitude are encoded. The encoded amplitudes CA are obtained.

During a step E6, each coefficient of the block RQ is associated with a context Cxj among a plurality J of predetermined contexts, with J a non-zero integer. Such a context is defined by at least one encoding characteristic of the coefficient or block from which it is derived.

Advantageously, the following features are considered:
the size of the block RQ,
the amplitude of the coefficient quantized RQ [i],
the frequency coefficient or index i in the block RQ,
the prediction mode of the current block mk among K possible modes.

Indeed, the prediction of the sign is all the more reliable as the amplitude is high. Similarly, it has been found that when the block is larger, the frequency of the coefficient is lower, the prediction is more reliable. Finally, it has been found that prediction is more reliable when the current block is associated with an intra-prediction of a certain type.

Alternatively, other contexts can be envisaged. Thus, it is possible to take account of the type of image in which the current block, for example of the Intra or Inter type, known from the HEVC standard, is based on the energy of the predictor P, or as a function of the total number of non-zero coefficients in the current block.

During a step E7, the signs of the coefficients of the block RQ to be predicted are selected as a function of a predetermined score Sj, with j an integer between 1 and J, for the context Cxj associated with the coefficient RQ [i].

Such a score Sj is representative of a level of reliability of the sign of the coefficient

RQ [i].

According to a first embodiment of the invention, the score Sj takes on values in a predetermined set, for example from 0 to 10.

According to a second embodiment, the score is a simple binary indication, one of the two values of which indicates that the sign will be predicted, and the other that the sign will not be predicted.

According to a third embodiment of the invention, the scores Sj correspond to probabilities known a priori, dependent on the context Cxj associated with the coefficient RQ [i]. A set of probabilities of correct detection of the signs of the coefficients RQ are provided in the encoder. For example, this set of probabilities is stored in memory.

These probabilities are constructed, before encoding and decoding, either by statistical accumulation on a set of signals representative of the signals to be encoded, or by mathematical calculation based on hypotheses on the distribution of the signs of the coefficients. For a coefficient RQ[i] associated with the context Cxj, one can thus obtain the score Sj[i] by calculating the correct probability p[l][mk][i][IRQ[i]l] de prediction of the sign of the coefficient RQ [i].

Advantageously, the signs to be predicted are selected by thresholding the scores with which they are associated. Thus, for each coefficient RQ[i] which has a sign (that is to say, which is not zero) and which is associated with a context Cxj of score Sj, the sign is predicted if and only if Sj>T, where T is a predetermined threshold, for example equal to 0.7. For example, the threshold T is known to the encoder and the decoder.

According to a variant, the threshold T can be chosen during encoding and written in the compressed file or in the bit stream comprising the encoded data representative of the digital image Im. For example, if the unit which performs the encoding does not have enough computing resources at a given time, it is possible to increase this threshold T in order to predict fewer signs and thus to implement fewer calculations.

It would also be possible to vary the threshold T as a function of the content of the images to be encoded: an image with a lot of content such as high luminosity variations or many movements would use a high threshold and an image with little content such as low luminosity variations or few movements would use a lower T-threshold, to smooth the complexity or memory required to encode each image.

In the embodiment of the invention of FIG. 1, the steps E6 and E7 of determining the context of the coefficients and the selection of signs to be predicted rely on the values of the quantized coefficients of the residue transformed block. Note that the invention is not limited to this particular case, wherein these steps can also be implemented before the quantization of coefficients in the residue block.

During a step E8, the set of signs RQ that are not predicted are encoded conventionally. It is known especially from the HEVC standard, particularly the article by Sole et al., already mentioned, the fact of transmitting each character as a bit 0 or 1, with a convention associating a sign to the plus sign and the other to the minus sign.

During a step E9, the signs selected are predicted as “to be predicted” in the block RQ. This is done by means known to the man of the art, for example using the technique described in the article by Ponomarenko et al, entitled <<Prediction of signs of DCT coefficients in block-based lossy image compression>>, published in the Proceedings of the Conference SPIE 6497, Image Processing: Algorithms and Systems V, 64970L, in February 2007.

In one embodiment of the invention, as many decoded blocks as combinatorics of signs to be predicted are constructed. Each decoded version uses a different combination of signs to be predicted. For example, let us assume that the block RQ equals {+8, +7, 0, −6, −3, 0, 0, 2, −1, 0, 0, 0, 0, 0, 0, 0}. Let us also assume that the signs to be predicted are those of the 1^{st} and 4^{th} coefficients (amplitude 8 and 6 respectively). We already know the signs of the 2^{nd}, 5^{th}, 8^{th} and 9^{th} coefficients that were not to be predicted. In our example, there are two signs to be predicted, which may take on the values {+,+} {+,−} {−,+} and {−,−}. So we shall build 4 following virtual blocks RQVs:

RQV0={+8, +7, 0, +6, −3, 0, 0, 2, −1, 0, 0, 0, 0, 0, 0, 0}

RQV1={+8, +7, 0, −6, −3, 0, 0, 2, −1, 0, 0, 0, 0, 0, 0, 0}

RQV2={−8, +7, 0, +6, −3, 0, 0, 2, −1, 0, 0, 0, 0, 0, 0, 0}

RQV3={−8, +7, 0, −6, −3, 0, 0, 2, −1, 0, 0, 0, 0, 0, 0, 0}

Each block of RQVs is then decoded with conventional means of dequantization and of inverse transform, adds to them the predicted block P, to produce S virtual decoded blocks BDVs. The likelihood of each of these blocks is tested with a likelihood criterion. The solution applied is the combination of signs corresponding to the virtual decoded block that maximizes the likelihood criterion.

Advantageously, the likelihood criterion used consists in minimising the squared error along the border between the virtual decoded block and the previously decoded pixels.

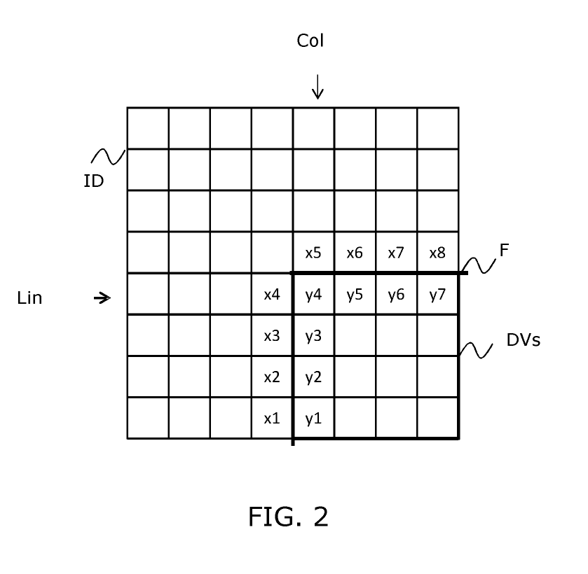

In connection with FIG. 2, there is shown a decoded image ID and a virtual decoded block DVs of size N×N pixels of the image, where DVs(n, m) is the value of the pixel of the block DVs located on the n^{th} row and the m^{th} column of the block. The broken line F represents the boundary between the virtual decoded block and the rest of the image (previously decoded). ID(k,l) is the value of the pixel of ID on the k^{th} row and the i^{th} column of the image, and (lin,col) are the coordinates of the block DVs (coordinates of the pixel in the upper left portion of DVS) in the image ID. We consider an operator “Matching Side” SM(ℑ,B)), with ℑ current image and B current block, defined as follows:

$$SM ( , B ) = {\sum }_{a = 0}^{N - 1} {( B ( 0 , a ) - ( lin - 1 , col + a ) )}^{2} + {\sum }_{a = 0}^{N - 1} {( B ( a , 0 ) - ( lin + a , col - 1 ) )}^{2}$$

In FIG. 2, this amounts to forming the sum (x1−y1)²+(x2−y2)²+(x3−y3)²+(x4−y4)²+(x5−y4)²+(x6−y5)²+(x7−y6)²+(x8−y7)².

We will determine the best virtual decoded block DVopt that minimises this measure: DVₒₚₜ=argmin_{Dv}_{_{S}}SM(ID,DV_{S})

where ID represents the reconstructed image after decoding.

Alternatively, the likelihood criterion used consists in minimising the error with the predictor P, i.e. in selecting the virtual decoded block which minimises the error with the predictor P. The virtual residue associated with the optimal virtual decoded block is so identified. For example, let us assume DVₒₚₜ=DV3, the associated virtual block is RQV3. We then consider the signs assigned to the identified virtual residue in our example {−,−}. These signs become prediction of signs: the prediction associated with the sign the 1^{st} coefficient is − and the prediction associated with the sign of the 4^{th} coefficient is also −.

During a step E10, for each sign to be predicted, a piece of information representing the difference between the prediction of the sign and the actual value of the sign, called prediction indicator IP or residue of the sign is calculated.

Thus, in the above example, the sign prediction is {−,−} while the real signs are {+,−}. By convention, the prediction indicator IP is set to 1 when the prediction is correct and 0 when the prediction is incorrect.

During a step E11, the values of the prediction indicator IP for each sign to be predicted are coded by a known technique of entropy coding, as for example Huffman coding, arithmetic coding or still CABAC encoding such that used in the HEVC standard. This gives a CIP value of the encoded prediction indicator.

According to the invention, since only the signs that are associated with a score representative of a sufficient level of reliability are predicted, the prediction indicator is set to 1 more often than to the value 0. This is exploited by entropy coding to reduce the size of the compressed signal.

Advantageously, the entropy coding takes into account the score Sj associated with the sign predicted to encode the indicator IP. For example, in the embodiment of the invention in which the score has a value between 0 (low reliability of the prediction) and 10 (high reliability of the prediction), the entropy coding of the indicators is set taking into account the score, in order to exploit the more or less uniform distribution of indicators. For example, we use a CABAC-type entropy coding, known from the HEVC standard, by setting the probabilities used in CABAC based on predetermined scores.

During a step E12, we construct the decoded block D corresponding to the block RQ, by applying to the quantized residual RQ the steps of dequantization and of inverse transform (known per se). The result is a decoded residual block RD. The block predictor P is added to RD to obtain the decoded block D.

During this step, the decoded block D is also added to the reconstructed image ID. This allows to have a decoded version of the current image in the encoder. This decoded version is used in particular during the step of constructing a prediction of the selected symbols to be predicted.

During a step E13, the encoded data, i.e. the amplitudes of the coefficients CA, the non-predicted encoded signs CS, the indicators of the predicted signs CIP are inserted into the bit stream TB or in the compressed file FC.

During a step E14, we test whether the current block C is the last block to be processed by the encoding unit, given the route order previously defined. If so, the encoding unit has completed its treatment. If not, the next step is the step of selecting the next block E0. This block becomes the current block to be processed, and the next step is the prediction step E1.

In an exemplary embodiment of the invention, the context Cxj depends on the size of the blocks l (among four possible sizes, as described above) of the intra prediction mode mk among 35 possible prediction modes (as described in the standard HEVC mentioned above), on the frequency i (from 16, 64, 256 or 1024 possible frequencies, depending on the block size), and on the amplitude IRQ[i] I (which can take on 256 possible values when it is encoded on 8 bits). In this example, the number of contexts used for J is equal to 35×(16+64+256+1024)×256=12185600.

Preliminary screening on typical video sequences enables to calculate a correct detection probability of the sign for each context Cxj. This probability is the score Sj associated with each context Cxj, which selects the signs to be predicted from a threshold of 0.7, as described above. Thus, a compression gain of 1 to 2% is observed with respect to the state of the art.

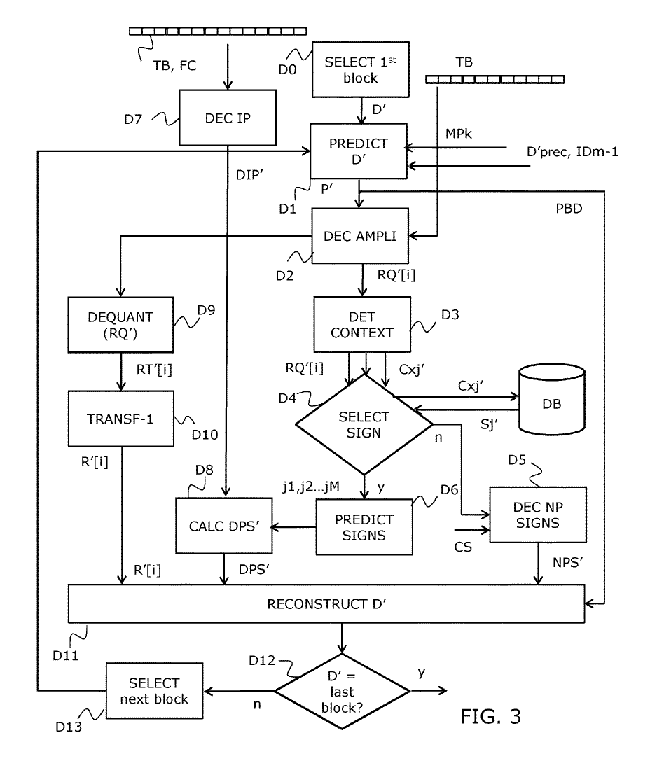

In relation to FIG. 3, the steps of the encoding method of a digital image encoded according to an exemplary embodiment of the invention are now illustrated.

A bit stream TB or a compressed file FC produced by the encoding method according to the invention which has just been described, are considered. Either of them encodes a video composed of a sequence of M digital images Im, with a non-zero integer M and m ab integer between 1 and M. A picture Im is divided into blocks of size N×N, wherein N is a non-zero integer and for example equal to 4, 8, 16 or 32 pixels.

The decoding method according to the invention includes a D0 stage of selecting a first decoded block D′, which is identical to step E0 for selecting a first block to be encoded shown in connection with FIG. 1.

In a step D1, a prediction V of the block to be decoded D′ is determined. The prediction information related to P is encoded in the bit stream or the compressed file and are decoded. Such information includes a prediction mode mk of the current block to be decoded C′.

According to a variant, the prediction mode may instead be completely inferred.

In a step D2, the amplitude information of a quantized residual block RQ′ corresponding to the block to be decoded D′ is read from the bit stream or the compressed file and then decoded. Upon completion of this step, we know therefore the amplitudes of the coefficients of the quantized residual block RQ′[i], with i an integer between 1 and N×N, but not the signs yet.

During a step D3, the encoding contexts Cxj′ of the coefficients of the quantized residual block RQ′ are determined among a plurality of preset contexts. This step is identical to that of the encoding method.

In a step D4, the signs of the coefficients RQ′ [i] to predict are selected. This step is identical to that used in encoding. It associates to each coefficient RQ′[i] the encoding context Cxj′ previously determined and is based on a predetermined score Sj′ representative of a level of reliability of a prediction of the sign for the context Cxj′ of coefficient considered.

During a step D5, the non-predicted signs are decoded with means adapted to those used during encoding. Typically, the decoding method implemented is binary, such an entropic or Huffman decoding method. The result is a plurality of the decoded non-predicted signs NPS′.

In a step D6, the signs of the coefficients selected are predicted. This step is identical to that used in encoding. We thus obtain a list of virtual residual blocks RQV′, similar to that of residual blocks RQV obtained from the encoder. Each block of RQV′ is then decoded with conventional means of dequantization and of inverse transform, added to the predicted block P, to produce S virtual decoded blocks BDV's. The likelihood of each of these blocks is tested with a likelihood criterion. The solution adopted is the combination of signs which maximises this criterion.

In the previous example, it was the combination {−,−}.

During a step D7, the DIP′ values are extracted from the bit stream and decoded from a prediction indicator IP of the predicted signs. This is a piece of information representative of a difference between the prediction of a sign and the actual value of this sign, that is to say a sign residue. It can take on the following values:
a value representative of a correct prediction;
a value representative of an incorrect prediction.

In a step D8, the values of this indicator IP in the current quantized residual block RQV′ are used to correct, if needed, the predicted values of the selected signs.

Thus, in the previous example, the values of the prediction indicator present in the bit stream are representative of a first false prediction and a second accurate prediction. This allows us to decode the actual signs of the coefficients of the current residual block {+,−}, and to rebuild the full decoded residue RQ′={+8, +7, 0, −6, −3, 0, 0, 2, −1, 0, 0, 0, 0, 0, 0, 0}.

In a step D9, the block RQ is dequantized to obtain a dequantized block RT′. This is achieved by means appropriate to the quantization used during encoding (scalar dequantization, vector dequantization . . . )

In a step D10, an inverse transform from that used in encoding is applied to the dequantized residual RT′. The decoded residue R′ is then obtained.

In a step D11, the decoded residue R′ is added to the prediction P′, to reconstruct the decoded block D′. The block D′ is integrated with the image ID being decoded.

During a step E12, we test whether the current block is the last block to be processed by the decoding unit, given the route order previously defined. If so, the encoding unit has completed its treatment. If not, the next step is the step of selecting the next block D0.

In a step D13, we select the next block to be processed by the decoding unit, following the route defined previously. This block becomes the current block to be decoded, and the next step is the prediction step D1.

It will be noted that the invention just described, can be implemented using software and/or hardware components. In this context, the terms “module” and “entity” used in this document, can be either a software component or a hardware component or even a set of hardware and/or software, capable of implementing the functions outlined for the module or entity concerned.

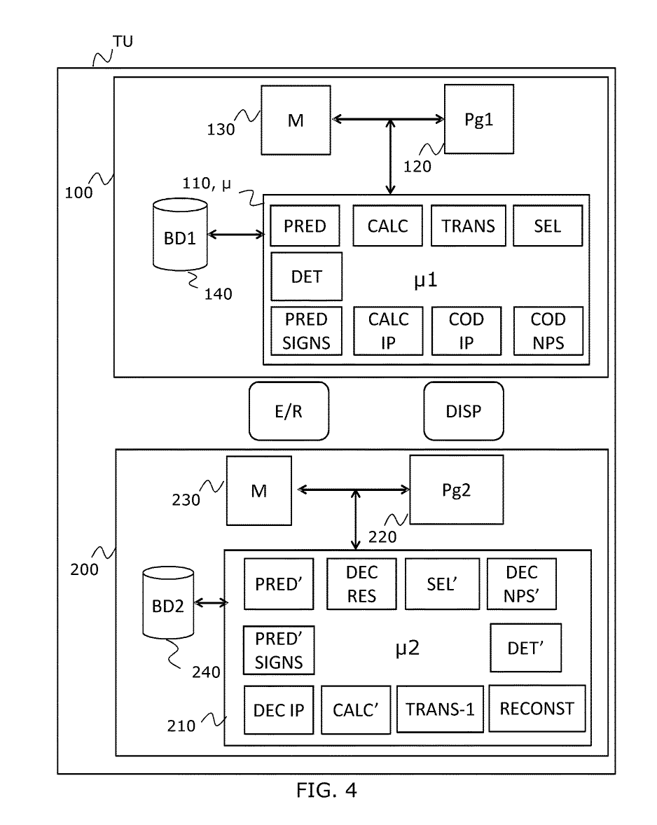

In relation to FIG. 4, we now present an example of simplified structure of an encoding device 100 of a digital image according to the invention. The device 100 implements the encoding method according to the invention which has just been described in connection with FIG. 1.

For example, the device 100 comprises a processing unit 110, equipped with a processor μl and driven by a computer program Pg1 120 stored in a memory 130 and implementing the encoding method according to the invention.

At initialisation, the computer program code instructions Pg₁ 120 are for example loaded into a RAM before being executed by the processor of the processing unit 110. The processor of the processing unit 110 implements the method steps described above, according to the instructions of the computer program 120.

In this embodiment of the invention, the device 100 comprises at least one unit PRED for predicting the values of the current block from at least one previously processed block according to a prediction mode selected from a plurality of predetermined modes, a unit CALC for calculating a residual block by subtracting the predicted values from the original values of the current block, a unit TRANS for obtaining a transformed residual block by applying a transform to the pixels of the residual block, said transformed residual block comprising coefficients, a unit DET for determining a context of a coefficient of the current residual block among a plurality of predetermined settings, using at least one characteristic belonging to a group comprising at least the block size, the amplitude of the coefficient, the frequency of the coefficient and the prediction mode of the current block, a unit SEL for selecting signs of the coefficients to be predicted in the current block, the sign of a coefficient of the transformed residual block being selected according to a predetermined score associated with the encoding context of said coefficient, said score being representative of a level of reliability of the prediction of the sign, a unit PRED SIGNS for predicting signs selected in the current block from encoded neighbouring blocks decoded according to an error minimisation criterion, a unit CALC IP for calculating a sign prediction indicator selected from the predictions of the selected signs and their original values, the indicator being designed to take on a value in a group comprising a first value representative of a correct prediction and a second value representative of an incorrect prediction, a unit COD IP of entropic encoding of indicator values obtained for the predicted signs and a unit COD NPS of encoding non-predicted signs.

The device 100 further comprises a unit BD1 for storing the encoding contexts of the predetermined coefficients and scores associated with each of these contexts.

These units are controlled by the processor μl of the processing unit 110.

Advantageously, such a device 100 can be integrated into a user terminal TU. The device 100 is then arranged to cooperate at least with the next module of the terminal TU:
a E/R module for sending and receiving data via which the bit stream TB or the compressed file FC is transmitted in a telecommunications network, for example a wired network or a wireless network.

Still in relation to FIG. 4, we now present an example of simplified structure of a decoding device 200 of a digital image according to the invention. The device 200 implements the decoding method according to the invention which has just been described in connection with FIG. 3.

For example, the device 200 comprises a processing unit 210, equipped with a processor μ2 and driven by a computer program Pg2 220 stored in a memory 230 and implementing the decoding method according to the invention.

At initialisation, the computer program code instructions Pg2 220 are for example loaded into a RAM before being executed by the processor of the processing unit 210. The processor of the processing unit 210 implements the method steps described above, according to the instructions of the computer program 220.

In this embodiment of the invention, the device 200 includes at least one unit PRED′ for predicting the current block from at least one previously processed block and from information about a prediction mode of the current block, unit DEC RES of entropic decoding of the encoded amplitudes of the coefficients of a residual block extracted from the bit stream, said residual block has been obtained by subtracting the predicted values from said at least one previously processed block and information about a prediction mode mk of the current block, from the original values of the current block, a unit DET′ for determining a context of a coefficient of the current residual block among a plurality of predetermined settings, using at least one characteristic belonging to a group comprising at least the block size, the amplitude of the coefficient, the frequency of the coefficient and the prediction mode of the current block, a unit SEL′ for selecting signs of the coefficients to be predicted in the transformed residual block, the sign of a coefficient of the current residual block being selected according to a predetermined score associated with the encoding context of said coefficient, said score being indicative of a level of reliability of the prediction of the sign, a unit DEC NPS' of decoding non-predicted signs from the encoded data extracted from the bit stream, a unit PRED′ SIGNS for predicting the values of the signs selected from the signs of pixels of at least one decoded neighbouring block of the current block using an error minimisation criterion, a unit DEC IP of decoding prediction indicator values of the signs selected from the encoded data extracted from the bit stream, the indicator being designed to take on a value in a group comprising a first value representative of a correct prediction and a second value representative of an incorrect prediction, a unit CALC′ of the decoded values of the signs predicted from the decoded prediction indicator values of the selected signs, a unit TRANSF-1 of inverse transform of coefficients amplitudes of the transformed residual block RQ[i], a unit RECONST for reconstructing the coefficients of the residual block from the decoded amplitudes and the decoded signs.

The device 200 further comprises a unit BD2 for storing the encoding contexts of the predetermined coefficients and scores associated with each of these contexts.

These units are controlled by the processor μ2 of the processing unit 210.

Advantageously, such a device 200 can be integrated into a user terminal UT. The device 200 is then arranged to cooperate at least with the next module of the terminal UT:
A E/R module for sending and receiving data via which the bit stream TB or the compressed file FC is received from a telecommunications network;
A device DISP for restituting images, for example a terminal monitor, via which the decoded digital image or the series of decoded images is restituted to a user.

An exemplary embodiment of the present invention improves the situation described above with respect to the prior art.

An exemplary embodiment overcomes these shortcomings of the prior art.

More precisely, an exemplary embodiment proposes a solution that more effectively selects the signs to be predicted.

An exemplary embodiment proposes a solution that is more efficient in compression.

It goes without saying that the embodiments which have been described above have been given by way of purely indicative and non-limiting example, and that many modifications can be easily made by those skilled in the art without departing from the scope of the invention.

1. An encoding method of a digital image, said image being divided into a plurality of blocks of pixels processed in a set order, said method comprising the following acts, implemented for a current block by an encoding device:
predicting the current block values from at least one block previously processed in a mode of prediction selected from a plurality of predetermined modes,
calculating a residual block by subtracting the predicted values from the original values of the current block,
obtaining a residual block transformed by applying a transform to pixels of the residual block, said transformed residual block comprising coefficients,
selecting the coefficients signs to be predicted in the transformed residual block;
predicting the signs selected;
calculating a prediction indicator of the signs selected from the predictions of the selected signs and their original values, the indicator being taking a value among a group consisting of:
a first value representative of a correct prediction;
a second value representative of an incorrect prediction;
entropic encoding of the values of indicators obtained for the predicted signs; and
determining a context of a coefficient of the current residual block among a plurality of predetermined contexts, using at least one characteristic belonging to a group comprising at least:
the size of the block,
the amplitude of the coefficient,
the frequency of the coefficient,
the prediction mode of the current block; and
wherein sign of a coefficient of the transformed residual block is selected based on a score associated with the predetermined encoding context of said coefficient, said score being indicative of a level of reliability of the prediction of the sign.

2. The encoding method of a digital image according to claim 1, wherein the score is predetermined during a preliminary act of estimating a probability of correct prediction of the sign in the context of the coefficient.

3. The encoding method of a digital image according to claim 1, wherein the sign of a quantized coefficient is selected when said score is greater than a predetermined threshold.

4. The encoding method of a digital image according to claim 1, wherein the score can take on binary values, a first value being representative of a sign to be predicted, a second value being representative of a sign not to be predicted.

5. The encoding method of a digital image according to claim 3, wherein the threshold value is predetermined.

6. The encoding method of a digital image according to claim 3, wherein the threshold value is adapted during encoding based on the encoding characteristics.

7. The encoding method of a digital image according to claim 1, wherein entropic encoding the prediction indicator value of the sign of a coefficient takes into account the predetermined score associated with the encoding context of the coefficient.

8. An encoding device of a digital image, said image being divided into a plurality of blocks of pixels processed in a set order, said device comprising:
a non-transitory computer-readable medium comprising instructions stored thereon;
a processor configured by the instructions to perform the following acts implemented for a current block of the plurality of blocks:
predicting the current block values from at least one block previously processed in a mode of prediction selected from a plurality of predetermined modes;
calculating a residual block by subtracting the predicted values from the original values of the current block;
obtaining a transformed residual block by applying a transform to pixels of the residual block, said transformed residual block comprising coefficients;
selecting the coefficients signs to be predicted in the residual block transformed;
predicting the signs selected;
calculating a prediction indicator of the signs selected from the predictions of the selected signs and their original values, the indicator taking a value among a group consisting of:
a first value representative of a correct prediction;
a second value representative of an incorrect prediction;
of entropic encoding the values of indicators obtained for the predicted signs;
determining a context of a coefficient of the current residual block among a plurality of predetermined contexts, using at least one characteristic belonging to a group comprising at least:
the size of the block,
the amplitude of the coefficient,
the frequency of the coefficient,
the prediction mode of the current block; and
wherein the sign of a coefficient of the transformed residual block is selected based on a predetermined score associated with the encoding context of said coefficient, said score being indicative of a level of reliability of the prediction of the sign.

9. A decoding method of a digital image from a bit stream comprising encoded data representative of said image, said image being divided into a plurality of blocks of pixels processed in a set order, said method comprising the following acts, implemented for a current block of the plurality of blocks:
predicting the current block from at least one block previously processed and information related to a prediction mode of the current block;
entropic decoding the encoded amplitudes of the coefficients of a transformed residual block, extracted from the bit stream;
selecting the coefficients signs to be predicted in the transformed residual block;
predicting the values of the signs selected;
decoding the values of prediction indicators of the signs selected from encoded data extracted from the bit stream, the indicator taking on a value in a group consisting of:
a first value representative of a correct prediction;
a second value representative of an incorrect prediction;
calculating the decoded values of the signs selected from the decoded prediction indicator values;
reconstructing coefficients of the residual block from the decoded amplitudes, and decoded signs;
determining a context of a coefficient of the current residual block among a plurality of predetermined contexts, using at least one characteristic belonging to a group comprising at least:
size of the block,
amplitude of the coefficient,
frequency of the coefficient,
prediction mode of the current block; and
wherein the sign of a coefficient of the transformed residual block is selected based on a predetermined score associated with the encoding context of said coefficient, said score being indicative of a level of reliability of the prediction of the sign.

10. A decoding device of a digital image from a bit stream comprising encoded data representative of said image, said image being divided into a plurality of blocks of pixels processed in a set order, said device comprising:
a non-transitory computer-readable medium comprising instructions stored thereon;
a processor configured by the instructions to perform the following acts implemented for a current block of the plurality of blocks:
predicting the current block from at least one block previously processed and information related to a prediction mode of the current block;
entropic decoding of the encoded amplitudes of the coefficients of a residual block transformed, extracted from the bit stream;
selecting the coefficients signs to be predicted in the residual block transformed;
predicting the values of the signs selected;
decoding the values of prediction indicators of the signs selected from encoded data extracted from the bit stream, the indicator taking on a value in a group consisting of:
a first value representative of a correct prediction;
a second value representative of an incorrect prediction;
calculating the decoded values of the signs selected from the predicted values and from the decoded prediction indicator values;
determining a context of a coefficient of the current residual block among a plurality of predetermined contexts, using at least one characteristic belonging to a group comprising at least:
size of the block,
amplitude of the coefficient,
frequency of the coefficient,
prediction mode of the current block; and
wherein the sign of a coefficient of the transformed residual block is selected based on a predetermined score associated with the encoding context of said coefficient, said score being indicative of a level of reliability of the prediction of the sign.

11. (canceled)

12. The encoding device of claim 8, implemented in a user terminal.

13. A non-transitory computer-readable medium comprising a computer program stored thereon and comprising instructions for implementing an encoding method of a digital image, said image being divided into a plurality of blocks of pixels processed in a set order, when the instructions are executed by a processor of an encoding device, wherein the instructions configure the encoding device to perform the following acts implemented for a current block:
predicting the current block values from at least one block previously processed in a mode of prediction selected from a plurality of predetermined modes,
calculating a residual block by subtracting the predicted values from the original values of the current block,
obtaining a residual block transformed by applying a transform to pixels of the residual block, said transformed residual block comprising coefficients,
selecting the coefficients signs to be predicted in the transformed residual block;
predicting the signs selected;
calculating a prediction indicator of the signs selected from the predictions of the selected signs and their original values, the indicator being taking a value among a group consisting of:
a first value representative of a correct prediction;
a second value representative of an incorrect prediction;
entropic encoding of the values of indicators obtained for the predicted signs; and
determining a context of a coefficient of the current residual block among a plurality of predetermined contexts, using at least one characteristic belonging to a group comprising at least:
the size of the block,
the amplitude of the coefficient,
the frequency of the coefficient,
the prediction mode of the current block; and
wherein sign of a coefficient of the transformed residual block is selected based on a score associated with the predetermined encoding context of said coefficient, said score being indicative of a level of reliability of the prediction of the sign.

14. A non-transitory computer-readable medium comprising a computer program stored thereon and comprising instructions for implementing a decoding method of a digital image from a bit stream comprising encoded data representative of said image, said image being divided into a plurality of blocks of pixels processed in a set order, when executed by a processor of a decoding device, wherein the instructions configure the decoding device to perform the following acts implemented for a current block:
predicting the current block from at least one block previously processed and information related to a prediction mode of the current block;
entropic decoding the encoded amplitudes of the coefficients of a transformed residual block, extracted from the bit stream;
selecting the coefficients signs to be predicted in the transformed residual block;
predicting the values of the signs selected;
decoding the values of prediction indicators of the signs selected from encoded data extracted from the bit stream, the indicator taking on a value in a group consisting of:
a first value representative of a correct prediction;
a second value representative of an incorrect prediction;
calculating the decoded values of the signs selected from the decoded prediction indicator values;
reconstructing coefficients of the residual block from the decoded amplitudes, and decoded signs;
determining a context of a coefficient of the current residual block among a plurality of predetermined contexts, using at least one characteristic belonging to a group comprising at least:
size of the block,
amplitude of the coefficient,
frequency of the coefficient,
prediction mode of the current block; and
wherein the sign of a coefficient of the transformed residual block is selected based on a predetermined score associated with the encoding context of said coefficient, said score being indicative of a level of reliability of the prediction of the sign.

15. The decoding device of claim 10, implemented in a user terminal.
